(19) United States
(12) Patent Application Publication
(10) Pub. No.: US 2015/0027309 A1
(43) Pub. Date: Jan. 29, 2015

(54) SELECTIVE ADSORBENT

(71) Applicant: NORTHWESTERN UNIVERSITY, Evanston, IL (US)

(72) Inventors: Chang Y. Lee, Daejeon (KR); Omar K. Farha, Glenview, IL (US); SonBinh T. Nguyen, Evanston, IL (US); Joseph T. Hupp, Northfield, IL (US); Randall Q. Snurr, Evanston, IL (US); Youn-Sang Bae, Seoul (KR)

(73) Assignee: Northwestern University, Evanston, IL (US)

(21) Appl. No.: 14/380,108

(22) PCT Filed: Mar. 15, 2013
(86) PCT No.: PCT/US2013/032121

§ 371 Date: Aug. 21, 2014

Related U.S. Application Data
(60) Provisional application No. 61/611,961, filed on Mar. 16, 2012.

(51) Int. Cl. B01J 20/26; C07F 7/10; B01D 53/02

(52) U.S. Cl. CPC B01J 20/262; B01D 53/02; C07F 7/10; B01D 2253/204; B01D 2257/702
USPC 95/144; 95/90; 95/143; 546/2

(57) ABSTRACT

Embodiments include selective adsorbents having a structure of Formula (I) where a connection to X represents a connection to a structure of Formula (II), and a connection to Y represents a connection to a structure of Formula (III), where each R¹ is independently selected from the group consisting of fluorine, chlorine, bromine, and iodine, and each R² is independently selected from the group consisting of a hydrogen, an alkyl, an aryl, and a trisubstitutedsilyl group.

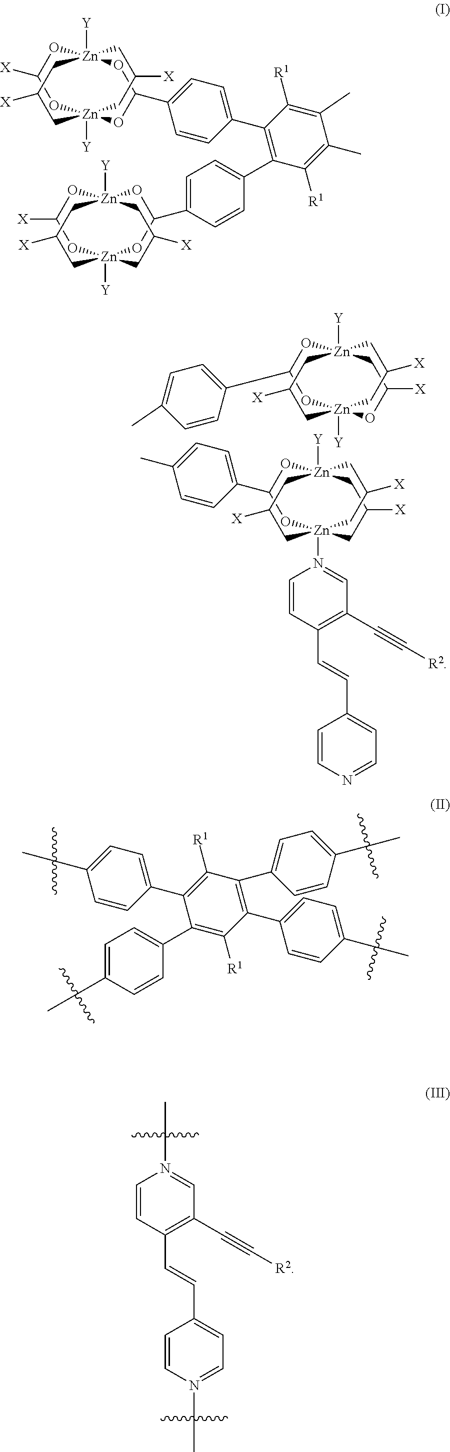

This disclosure relates to selective adsorbents and methods of selectively adsorbing a gas.

Olefins are used in production of plastics, fuels, nylons, pesticides, textiles, disinfectants, reagents, detergents, solvents, and others. Separating paraffins and olefins, e.g., those having the same number of carbon atoms, is a challenging process due to the similar physiochemical properties of the compounds.

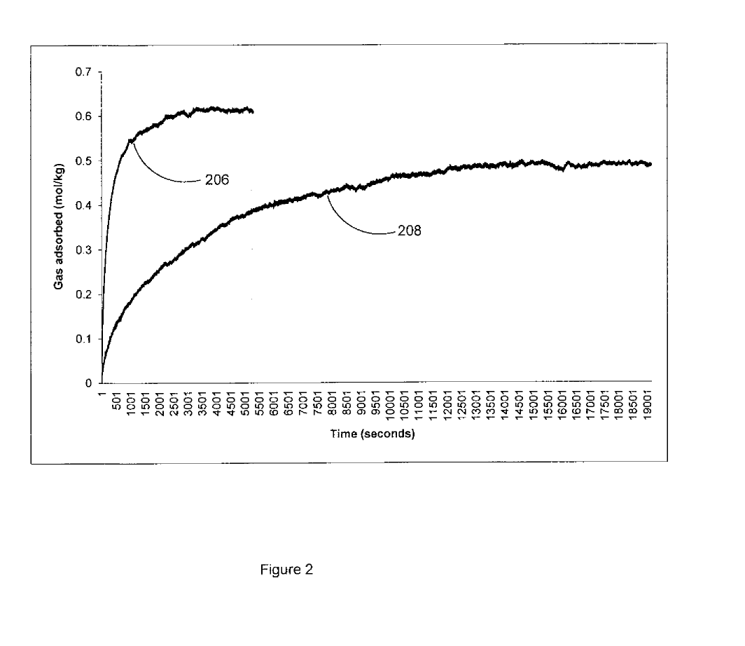

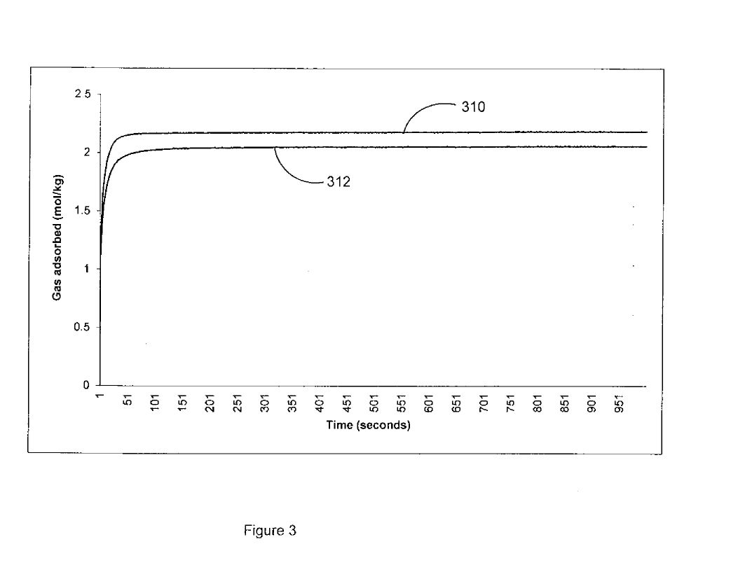

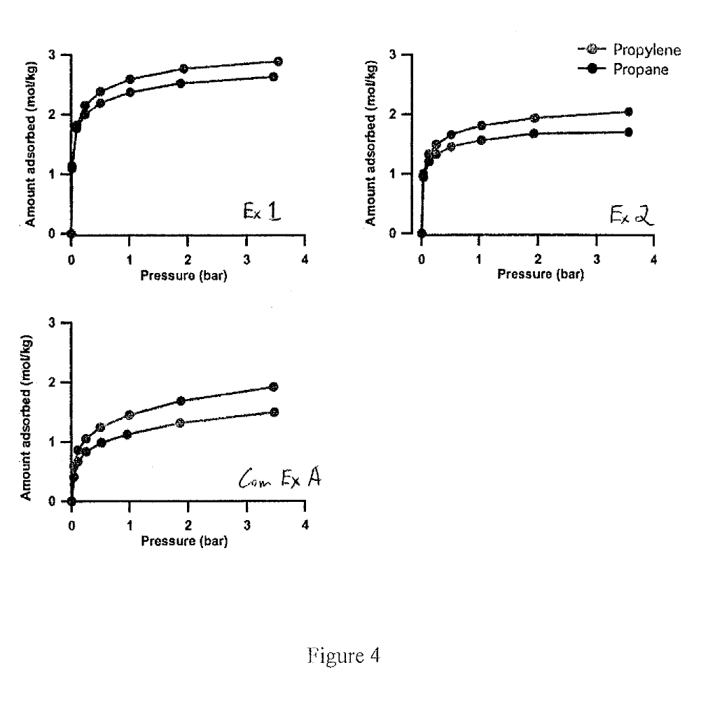

Figure (FIG.) 1 illustrates a gas adsorbed versus time diagram associated with a selective adsorbent in accordance with one or more embodiments of the present disclosure. FIG. 2 illustrates a gas adsorbed versus time diagram associated with a selective adsorbent in accordance with one or more embodiments of the present disclosure. FIG. 3 illustrates a gas adsorbed versus time diagram associated with a metal-organic framework. FIG. 4 illustrates adsorption equilibria versus pressure associated with materials described in Ex 1, Ex 2 and Corn Ex A.

This disclosure provides selective adsorbents having a structure of Formula I

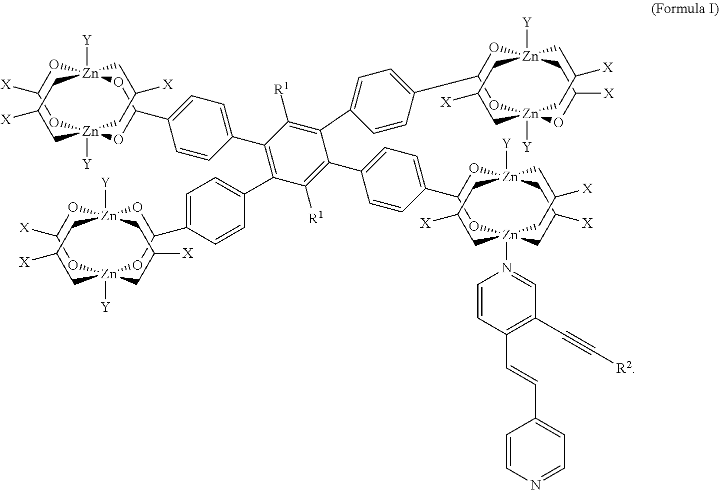

where a connection to X represents a connection to a structure of Formula II,

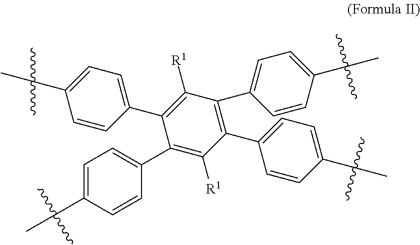

and a connection to Y represents a connection to a structure of Formula III,

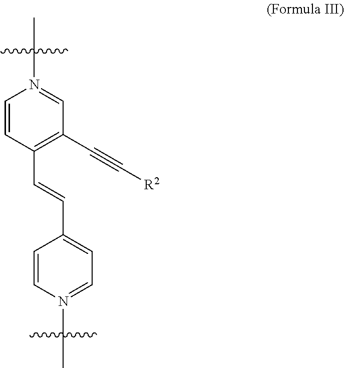

where each R¹ is independently selected from the group consisting of fluorine, chlorine, bromine, and iodine, and each R² is independently selected from the group consisting of a hydrogen, an alkyl, an aryl, and a trisubstitutedsilyl group. For the trisubstitutedsilyl group, the trisubstitution can be trialkyl, trialryl, or a combination thereof. The selective adsorbents can be repeating structures, e.g., including multiple Formula I, Formula II, and/or Formula III structures.

The disclosed selective adsorbents, which may be referred to as metal-organic frameworks or coordination polymers, are useful for separating paraffins and olefins. In one or more embodiments, the disclosed selective adsorbents can be obtained by reacting zinc ions with 3,6-dibromo-1,2,4,5-tetrakis(4-carboxyphenyl)benzene (R¹=bromine) and 3-[(trimethylsilyl)ethyriyl]-4-[2-(4′-pyridinyl)ethenyl]pyridine (R²=trimethylsilyl group). In one or more embodiments, employing the ligand 3-ethynyl-4-[2-(4′-pyridinypethenyl]pyridine provides selective adsorbents with R²=H.

This disclosure provides a method for selectively adsorbing a gas. The method includes contacting the selective adsorbent, as disclosed herein, with a gas. The gas can include an olefin in a gaseous state, such as propene, and a paraffin, such as propane. The method conditions include contacting the selective adsorbent with the gas at a temperature in a range of from −30 degrees Celsius (° C.) to 150° C. or from −30 degrees ° C. to 100° C., where adsorption can be carried out across the temperature range. The method conditions include contacting the selective adsorbent with the gas at a pressure in a range of from 5 kPa (kilopascal) to 10 MPa (megapascal), a pressure in a range of 5 kPa to 300 kPa, or at a pressure in a range of from 50 kPa to 300 kPa. As an example, the selective adsorbents can be used in a pressure swing adsorption process.

### EXAMPLES

All materials available from Sigma-Aldrich® or VWR International, LLC, unless otherwise noted. Use all materials without further purification, unless otherwise noted.

Prepare 3,6-dibromo-1,2,4,5-tetrakis(4-carboxyphenyl)benzene as follows (also described in J. Am. Chem. Soc., 2010, 132 (3), pp 950-952, incorporated in its entirety herein by reference). Add 100 milliliter (ml) of p-tolylmagnesium bromide (1 molar (M) in tetrahydrofuran (TIT), 100 millimole (mmol)) and 5 grams (g) of hexabromobenzene (9.07 mmol) to a container under nitrogen. Stir contents of container for 15 hours then place container in ice bath. Add drop wise a combination of 7 ml of bromine and 60 ml of carbon tetrachloride to the contents of the container. Stir contents of container for 1.5 hours then pour onto ice and add 50 ml of 6 M hydrochloric acid. Filter and wash solid with methanol. Add the solid, 24 ml of water, and 6 ml nitric acid to a Teflon-lined container. Seal the Teflon-lined lid and heat contents to 180° C. for 24 hours. Remove 3,6-dibromo-1,2,4,5-tetrakis(4-carboxyphenyl)benzene from the teflon lined container; filter and wash with THF/chloroform (7:3 v/v).

Prepare 3-[(trimethylsilyl)ethynyl]-4-[2-(4′-pyridinyl)ethenyl]pyridine as follows. Add 4-methylphosphonium pyridinium dichloride (2.245 g, 5.27 mmol) in THF (250 ml) to a container under nitrogen in an ice bath. Add potassium tert-butoxide (1.30 g, 11.6 mmol) to the contents of the container and stir for 30 minutes, then add 3-bromo-4-pyridine carboxaldehyde (980 milligrams (mg), 5.27 mmol). Remove the container from ice bath and stir for twelve hours at 23° C. Evaporate the contents of the container to dryness and then add dichloromethane (200 ml) to the contents of the container. Wash the contents of the container with saturated aqueous sodium bicarbonate (2×100 ml) and deionized water (2×100 ml), dry over anhydrous magnesium sulfate, and then evaporate to dryness. Collect solid and purify by flash column chromatography on silica gel, using a 56-millimeter (mm) inner diameter column containing 250 cubic centimeters (cm³) of silica gel under a positive pressure of lab air, with dichloromethane:acetone (7:3 v/v) as eluent to provide 3-bromo-4-[2-(4′-pyridinyl)ethenyl]pyridine.

Add bis(triphenylphosphine)palladium(II) dichloride (56 mg, 2 mole percent (mol %)), copper(I) iodide (40 mg, 5 mol %), and 3-bromo-4-[2-(4′-pyridinyl)ethenyl]pyridine (1.044 g, 4 mmol) to a container in a nitrogen-filled drybox while stirring. Add triethylamine (10 ml) and trimethylsilylacetylene (570 microliters (μl), 4.02 mmol to the contents of the container, seal the container and stir at 80° C. for two hours. Remove triethylamine under reduced pressure and dissolve remaining solids with dichloromethane. Purify by flash column chromatography on neutral alumina gel, using a 56-mm inner diameter column containing 250 cm³ of alumina under a positive pressure of lab air, with hexanes:ethyl acetate (7:3 v/v) as eluent. Combine fractions showing a single spot with Rf=0.25 and evaporate to dryness to provide 3-[(trimethylsilyl)ethynyl]-4-[2-(4′-pyridinyl)ethenyl]pyridine.

Prepare 3-ethynyl-4-[2-(4′-pyridinyl)ethenyl]pyridine as follows. Add 3-[(trimethylsilyl)ethynyl]-4-[2-(4′-pyridinyl)ethenyl]pyridine (0.500 g, 1.79 mmol), potassium carbonate (1.24 g, 8.95 mmol), and methanol (20 ml) to a container and stir for 30 minutes. Evaporate contents of container to dryness and add dichloromethane (3.5 ml). Perform flash column chromatography on contents of container, use neutral alumina gel, a 30-mm inner diameter column containing 150 cm³ of alumina under a positive pressure of lab air, with ethyl acetate as eluent. Combine fractions showing a single spot with R_{f}0.35 and evaporate to dryness to provide 3-ethynyl-4-[2-(4′-pyridinyl)ethenyl]pyridine.

### Example (Ex) 1

Prepare selective adsorbent having a structure of Formula I, where each R² is hydrogen, as follows. Combine 3-ethynyl-4-[2-(4′-pyridinyl)ethenyl]pyridine (285 mg, 1.37 mmol), 3,6-dibromo-1,2,4,5-tetrakis(4-carboxyphenyl)benzene (975 mg, 1.37 mmol), zinc nitrate hexahydrate (750 mg, 2.52 mmol), concentrated aqueous hydrogen chloride (15 drops), and dimethylformamide (112.5 ml) in a container with sonication (5 minutes). Divide contents of the container into 75 vials (1 dram). Cap vials and maintain at 80° C. for 48 hours to form crystals. Cool crystals to room temperature and combine all vials. Isolate crystals by decantation, rinse with dimethylformamide (50 ml), and filter to provide a selective adsorbent having a structure of Formula I, where each R² is a hydrogen.

### Ex2

Prepare selective adsorbent having a structure of Formula I, where each R² is a trimethylsilyl group, as follows. Combine 3-[(trimethylsilyl)ethynyl]-4-[2-(4′-pyridinyl)ethenyl]pyridine (126 mg, 0.454 mmol), 3,6-dibromo-1,2,4,5-tetrakis(4-carboxyphenyl)benzene (325 mg, 0.454 mmol), zinc nitrate hexahydrate (250 mg, 0.840 mmol), concentrated aqueous hydrogen chloride (4 drops), and dimethylformamide (35 ml) in a container with sonication (5 minutes). Divide contents of the container into 75 vials (1 dram). Cap vials and maintain at 80° C. for 48 hours to form crystals. Cool crystals to room temperature and combine all vials. Isolate crystals by decantation, rinse with dimethylformamide (50 ml), and filter to provide a selective adsorbent having a structure of Formula I, where each R² is a trimethylsilyl group.

### Comparative Example (Corn Ex) A

Prepare a metal-organic framework as follows. Combine 3-ethynyl-4-[2-(4′-pyridinyl)ethenyl]pyridine (92.5 mg, 0.448 mmol), 1,2,4,5 -tetrakis(4-carboxyphenyl)benzene (250 mg, 0.448 mmol), zinc nitrate hexahydrate (250 mg, 0.840 mmol), concentrated aqueous hydrogen chloride (5 drops), and dimethylformamide (37.5 ml) in a container with sonication (5 minutes). Divide contents of the container into 75 vials (1 dram). Cap vials and maintain at 80° C. for 48 hours to form crystals. Cool crystals to room temperature and combine all vials. Isolate crystals by decantation, rinse with dimethylformamide (50 ml), and filter to provide the metal-organic framework (also as described DTO-MOF in J. Am. Chem. Soc., 2011, 133 (14), pp 5228-5231, incorporated in its entirety herein by reference).

Determine selective adsorption of propene versus propane for the materials described in Ex 1, Ex, 2, and Corn Ex A.

### Ex 3

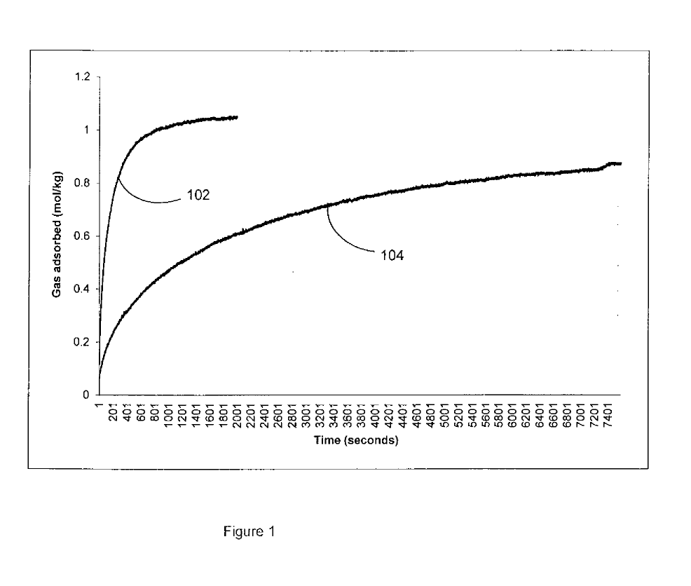

Determine time dependent gas uptakes of propene and propane for Ex 1. Load the material described in Ex I into volumetric system and maintain system at 25° C. Maintain pressure of propene at 0.3 bar and measure amount of propene adsorbed over time interval. Repeat with fresh Ex 1 material and propane. The results are shown in FIG. 1. Determine kinetic selectivity (selective adsorption) of propene over propane by determining the ratio of the diffusional time constants for propene and propane. The diffusional time constants

$$( \frac{D}{{r}_{c}^{2}} )$$

are determined by the equation:

$$\frac{{q}_{t}}{{q}_{∞}} = \frac{6}{\sqrt{π}} ( \sqrt{\frac{D}{{r}_{c}^{2}} t} )$$

where qₜ is the adsorbed amount at time t, q_{∞} is the adsorbed amount at equilibrium, r_{c} is the crystal radius, and D is the diffusivity. The results are shown in Table 1.

### Ex 4

Repeat Ex 3, but with change: use the material described in Ex 2 in place of that described in Ex 1. The results are shown in FIG. 2 and Table 1.

### Com Ex B

Repeat Ex 3, but with change: use the material described in Com Ex A in place of that described in Ex I. The results are shown in FIG. 3 and Table 1 respectively.

FIG. 1 illustrates a gas adsorbed versus time diagram associated with a selective adsorbent in accordance with one or more embodiments of the present disclosure. The selective adsorbent is Ex 1. Curve 102 illustrates uptake of propene and curve 104 illustrates uptake of propane. FIG. 1 illustrates that the material described in Ex 1 selectively adsorbs propene over propane because of the greater propene uptake over a shorter time interval as compared to propane.

FIG. 2 illustrates a gas adsorbed versus time diagram associated with a selective adsorbent in accordance with one or more embodiments of the present disclosure. The selective adsorbent is the material described in Ex 2. Curve 206 illustrates uptake of propene and curve 208 illustrates uptake of propane. FIG. 2 illustrates that the material described in Ex 2 selectively adsorbs propene over propane because of the greater propene uptake over a shorter time interval as compared to propane.

FIG. 3 illustrates a gas adsorbed versus time diagram associated with a metal-organic framework. The metal-organic framework is the material described in Corn Ex A. Curve 310 illustrates uptake of propene and curve 312 illustrates uptake of propane. FIG. 3 illustrates that the material described in Corn Ex A does not selectively adsorb propene over propane because of the similar propene and propane uptakes over the time interval.

TABLE 1

| | Diffusion time | Diffusion time | |
|---|---|---|---|
| | constant | constant | |
| Materials as | (D/r²) [s⁻¹] | (D/r²) [s⁻¹] | Kinetic |
| described in | Propene | Propane | selectivity |
| Ex 1 | 3.29 × 10⁻⁴ | 2.85 × 10⁻⁵ | 11.50 |
| Ex 2 | 1.31 × 10⁻⁴ | 1.07 × 10⁻⁵ | 12.20 |
| Com Ex A | 1.15 × 10⁻² | 8.06 × 10⁻³ | 1.42 |

The data in Table 1 shows that the materials described in Ex 1 and Ex 2 each have a kinetic selectivity for the adsorption of propene over propane greater than Corn Ex A. The data in Table 1 shows that the materials described in Ex 1 and Ex 2 are useful for selectively adsorbing propene over propane.

FIG. 4 illustrates the measurements of adsorption equilibria for the materials described in Ex 1, Ex 2 and Corn Ex A taken at a constant temperature of 298 K and over a pressure range of 0-355 kPa.

1. A selective adsorbent, comprising:
a structure of Formula I 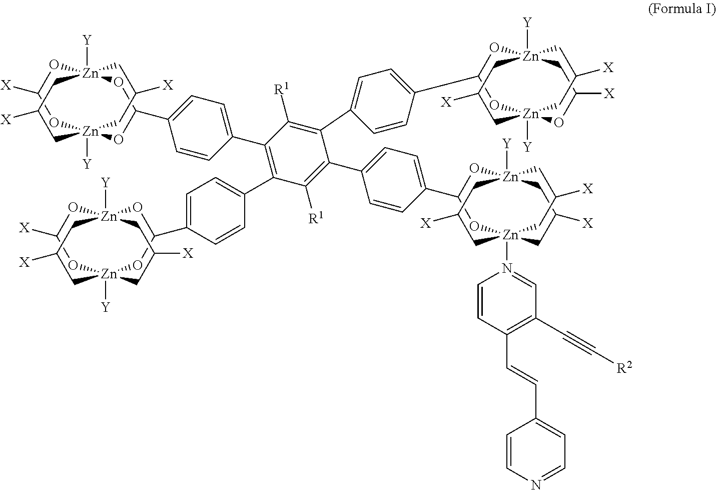
where a connection to X represents a connection to a structure of Formula II: 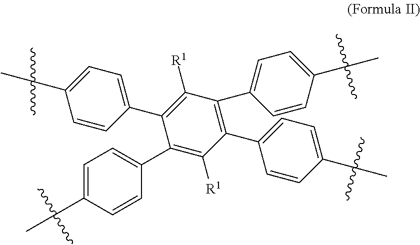
and a connection to Y represents a connection to a structure of Formula III: 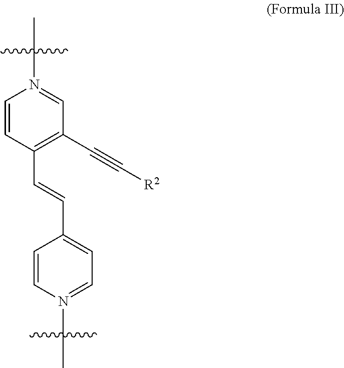
where each R¹ is independently selected from the group consisting of fluorine, chlorine, bromine, and iodine; and
each R² is selected from the group consisting of a hydrogen, an alkyl, an aryl, and a trisubstitutedsilyl group.

2. A method of selectively adsorbing a gas, the method comprising:
contacting the selective adsorbent of claim 1 with a gas.

3. The method of claim 2, wherein the gas includes an olefin.

4. The method of claim 3, wherein the olefin is propene.

5. The method of claim 2, wherein contacting the selective adsorbent with the gas occurs at a temperature in a range of from −30 degrees ° C. to 100° C.

6. The method of claim 2, wherein contacting the selective adsorbent with the gas occurs at a pressure in a range of from 50 kPa to 300 kPa.
